(19) United States
(12) Patent Application Publication
(10) Pub. No.: US 2016/0062991 A1
(43) Pub. Date: Mar. 3, 2016

(54) ELECTRONIC DISCOVERY MANAGEMENT SYSTEM

(71) Applicants: Jessica B. Reilly, Key Largo, FL (US); Michael C. Unger, Key Largo, FL (US)

(72) Inventors: Jessica B. Reilly, Key Largo, FL (US); Michael C. Unger, Key Largo, FL (US)

(21) Appl. No.: 14/836,871

(22) Filed: Aug. 26, 2015

Related U.S. Application Data
(60) Provisional application No. 62/041,815, filed on Aug. 26, 2014.

(51) Int. Cl. G06F 17/30; G06F 21/60; G06F 21/62; H04L 29/08

(52) U.S. Cl. CPC G06F 17/30011; G06F 17/30876; H04L 67/02; G06F 17/30312; G06F 21/602; G06F 21/6218

(57) ABSTRACT

An electronic discovery management system communicatively coupled with a communications network including a database for storing electronic documents, wherein each electronic document is associated with a fingerprint. The system also includes a server configured for: receiving a plurality of documents and generating a fingerprint of each document; receiving a request for a set of documents of the plurality of documents; accessing the set of documents in the database and generating a subsequent fingerprint for each document of the set, and comparing said subsequent fingerprint with a corresponding fingerprint stored in association with said document in the database; if, for each document of the set, said subsequent fingerprint is identical to the fingerprint stored in association with said document in the database, then transmitting, over the communications network, the set of documents; and providing documents that have not been tampered with.

### CROSS-REFERENCE TO RELATED APPLICATIONS

This patent application claims priority to provisional application No. 62/041,815 filed Aug. 26, 2014 and titled ELECTRONIC DISCOVERY MANAGEMENT SYSTEM. The subject matter of provisional application No. 62/041,815 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The disclosed embodiments relate generally to the field of electronic discovery for litigation and, more specifically, the disclosed embodiments relate to the management of electronic discovery documents.

### BACKGROUND

In a typical litigation process, large amounts of documents may be exchanged between parties in a process called discovery. When said discovery documents involve electronic documents, the process is referred to as electronic discovery. Electronic discovery is the exchange of documents and discovery of evidence in an electronic format. A chain of custody of discovery documents is the documentation and testimony that proves that particular evidence has not been altered or tampered with in any way since it was obtained. A clear chain of custody of discovery documents is necessary insure both its admissibility in a judicial proceeding and its probative value in any preceding investigation. Before a document may be admitted as evidence in a legal proceeding, the party seeking to have the evidence admitted must prove that the evidence has not been tampered with. Unless there is a stipulation as to the authenticity of the evidence, the entire chain of custody must be verified and proven to the satisfaction of the court. In the past, this could often be accomplished by reproducing a digital fingerprint of the electronic evidence in question and comparing it with the fingerprint of the evidence that was processed.

One of the current approaches to management of electronic discovery documents is described in U.S. Pat. No. 8,396,838, which discloses a method of electronic document handling to permit organizations to comply with legal or regulatory requirements, electronic discovery and legal hold requirements, and/or other business requirements. The systems described permit users to define and utilize information governance policies that help automate and systematize different compliance tasks and to detect when a legally sensitive production file has been changed or deleted.

Also, U.S. Pat. No. 6,738,760 describes a method for providing electronic discovery on computer systems and archives by using artificial intelligence to produce smart search agents to retrieve relevant data, particularly legally relevant documents. Information relevant to desired data related to an issue is input into a neural network to train said neural network to produce search algorithms in the form of smart search agent. The smart search agents are released onto target computer systems and/or archives to search for responsive data and documents.

Lastly, U.S. Pat. No. 8,924,395 discloses methods for processing electronically stored information in an electronic discovery environment. The methods describe processing electronically stored information in preparation for, or association with, litigation. The described process preserves the contextual relationships among documents when processing and indexing data, allowing for increased precision and recall during data analytics

Many of the currently available systems that handle electronic evidence and electronically stored information in an electronic discovery environment, however, do so in a way that destroys its evidentiary value, i.e., the entire chain of custody of said electronically stored information can no longer be verified and proven to the satisfaction of the court. Further, the existing tools and processes to properly handle electronic evidence and electronically stored information in an electronic discovery environment can be costly, technically complex and labor intensive. Additionally, the prior art may only digitally fingerprint documents sparingly during the evidence lifecycle, which reduces the usability of said fingerprinting.

Therefore, what is needed is a system and method for improving upon the problems with the prior art, and more particularly for a more efficient and cost-effective way to guarantee the authenticity of electronic documents during the discovery process.

### SUMMARY

An electronic discovery management system is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

The disclosed embodiments address deficiencies of the art in respect to authenticating electronic documents during the legal discovery process. In one embodiment, an electronic discovery management system communicatively coupled with a communications network is disclosed. The system includes a database for storing a plurality of electronic documents, wherein the database is coupled to the communications network. Each electronic document is associated with a fingerprint of each document. The system also includes a server communicatively coupled with the database. The server is configured for: 1) receiving a plurality of documents via the communications network, and storing the plurality of documents in the attached database; 2) generating a fingerprint of each document, by executing a mapping algorithm on each document that maps document data to a shorter bit string, wherein each fingerprint is associated with a corresponding document in the database; 3) receiving a request from a user, over the communications network, for a first set of documents of the plurality of documents; 4) accessing the first set of documents in the database; 5) generating a subsequent fingerprint for each document of the first set, and comparing said subsequent fingerprint with a corresponding fingerprint stored in association with said document in the database; 6) if, for each document of the first set, said subsequent fingerprint is identical to the fingerprint stored in association with said document in the database, then transmitting, over the communications network, the first set of documents to said user; 7) receiving a request, over the communications network, to store a second set of documents of the plurality of documents on a remote storage medium; 8) accessing the second set of documents in the database; 9) generating a subsequent fingerprint for each document of the second set, and comparing said subsequent fingerprint with a corresponding fingerprint stored in association with said document in the database; and 10) if for each document of the second set, said subsequent fingerprint is identical to the fingerprint stored in association with said document in the database, then transmitting, over the communications network, the second set of documents to the remote storage medium for storage.

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope. Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a block diagram illustrating a network architecture of a system for electronic discovery management over a communications network, in accordance with one embodiment.

FIG. 2A is a block diagram illustrating the control flow for a system for electronic discovery management over a communications network, in accordance with one embodiment.

FIG. 2B is a block diagram illustrating additional elements of the control flow for a system for electronic discovery management over a communications network, in accordance with another embodiment.

FIG. 3 is a block diagram illustrating the data flow for a system for electronic discovery management over a communications network, in accordance with one embodiment.

FIG. 4 is a block diagram of a system including an example computing device and other computing devices.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system and method that insures electronic evidence garnered during the legal discovery process (such as in a litigation environment) is not altered and maintains its integrity as it moves through the stages of the evidence life cycle. The system further overcomes the problems associated with the prior art by producing and comparing a digital fingerprint on each document whenever the document is accessed, transmitted to any user, or received for storage. The system also enables effective management of electronic evidence at a significantly lower cost than existing tools, processes or systems. Furthermore, the system reduces the technical skill required to manage electronic evidence, thereby providing a more user friendly system that may be used by a greater percentage of the working population.

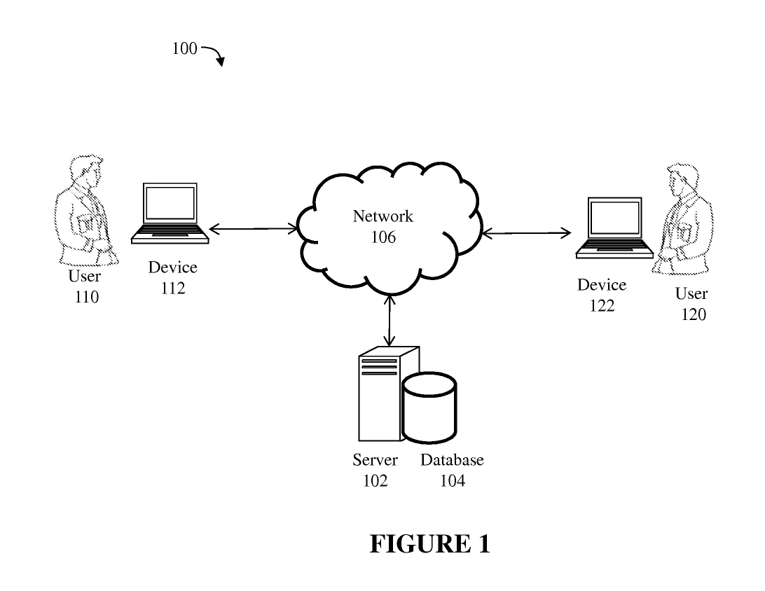

Referring now to the drawing figures in which like reference designators refer to like elements, there is shown in FIG. 1 is an illustration of a block diagram 100 showing the network architecture of an electronic discovery management system over a communications network.

A prominent element of FIG. 1 is the server 102 associated with repository or database 104 and further coupled with network 106, which can be a mobile telecommunications network, defined as a wireless network distributed over a land area. The wireless network may be connected to telephone exchanges (or switches), which in turn connect to the Public Service Telephone Network (PSTN). Network 106 may further be a circuit switched network, or a packet switched network, such as the Internet or the World Wide Web, the global telephone network, a cellular network, a mobile communications network, or any combination of the above. Server 102 is a central controller or operator for functionality of the disclosed embodiments, namely, facilitating dissemination of documents and reports to users over communications network 106.

FIG. 1 includes computing devices 112 and 122, which may be desktop computers, workstations, servers, smart phones, mobile phones, tablet computers, handheld computers, laptops, or the like. Computing devices 112 and 122 correspond to users 110 and 120, who may be any user of a computing device. Users 110 and 120 may also be referred to as administrators, clients or customers.

FIG. 1 further shows that server 102 includes a database or repository 104, which may be a relational database comprising a Structured Query Language (SQL) database stored in a SQL server or a big data database. Devices 112, 122 may also each include their own database. The repository 104 serves data from a database, which is a repository for data used by server 102 and devices 112, 122 during the course of operation of the disclosed embodiments. Database 104 may be distributed over one or more nodes or locations that are connected via network 106.

The database 104 may include a user record for each user 110 or 120. A user record may include: contact/identifying information for the user (name, address, telephone number(s), email address, date of birth, social security number, a photo, etc.), a user address identifier (such as an email address, text message address, UseNet address, mobile phone number, etc.), etc. A user record may also include a unique identifier for each user, a residential address for each user, the current location of each user (based on location-based services from the user's mobile computer) and demographic data for each user, such as age, sex, income data, race, color, marital status, etc. A user record may also include data about which documents in the database 104 were accessed by the user and at what time. The user record may also indicate the times and dates documents were accessed, any changes made to the document, the time and date the documents were checked back in and any copies made of said documents.

The database 104 may also hold a plurality of electronic documents, electronic discovery files, electronically stored information, litigation data, and other documents (collectively referred to as “documents”) related to a legal discovery process. A document or file record may include a unique identifier, a file name, permission data for the file, an operating system indicator, a file format indicator, a history of file modifications, a history of file accesses, metadata about the file, size of the file, native file format and a method of access indicator. Each electronic document may also associated with a fingerprint that is generated using a fingerprinting algorithm. A fingerprinting algorithm is a computer routine that maps an electronic document to a shorter bit string—its fingerprint—that uniquely identifies the document, just as human fingerprints uniquely identify people. A shorter bit string is a string of data that is shorter or has a smaller size than the original document it is meant to identify. A document record may also include data about which users accessed or requested said document in the database 104 and at what time. The document record may also indicate the times and dates the document was accessed, any changes made to the document, the time and date the document was checked back in and any copies made of said document.

In one embodiment, database 104 holds at least 1 million document records. This number of records is significant in the legal industry (especially with regard to massive or complex court cases, such as class actions, mass torts, etc.) because it represents a minimum number of documents that are present in a typical medium to large sized litigation (such as a mass tort multi-district litigation), and it represents a minimum number of documents that would be present in a medium to large sized litigation, since court cases of this type require a certain number of plaintiffs or aggrieved parties in order to make the costs of said litigation cost feasible for the attorneys prosecuting the cases for the plaintiffs. I.e., a minimum number of plaintiffs or aggrieved parties are necessary in these types of court cases in order to provide an acceptable return on investment on said medium to large sized litigation for the attorneys, and said minimum number of plaintiffs translates into a minimum of 1 million discovery documents involved in said litigation.

FIG. 1 shows an embodiment wherein networked computing devices 112, 122 interact with server 102 and repository 104 over the network 106 in the course of performing the claimed embodiments. Server 102 includes a software engine that delivers applications, data, documents, video files, audio files, program code and other information to networked computing devices 112, 122. It should be noted that although FIG. 1 shows only the networked computers 102, 112, 122, the system of the disclosed embodiments supports any number of networked computing devices connected via network 106. Further, server 102 and devices 112, 122 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 112, 122. Further, server 102 and its functionality, according to a preferred embodiment, can be realized in a centralized fashion in one computer system or in a distributed fashion wherein different elements are spread across several interconnected computer systems.

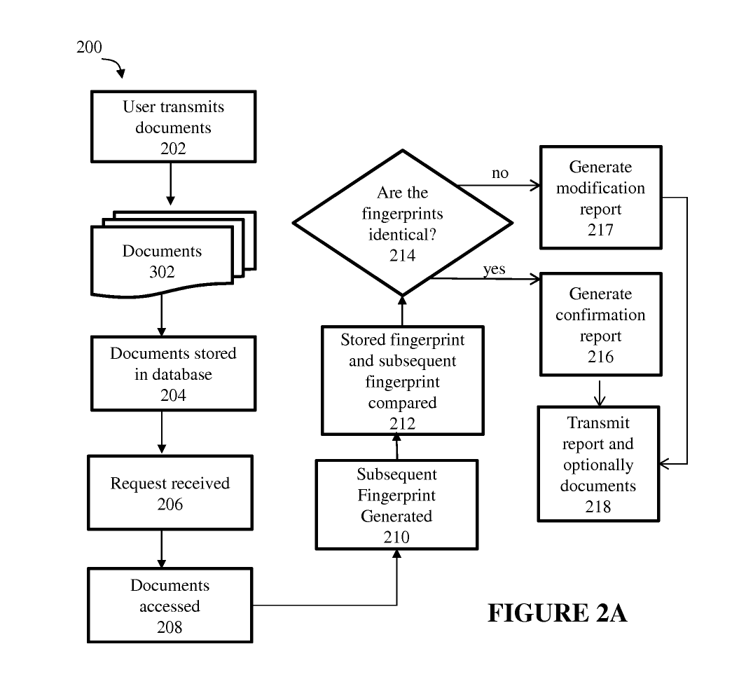

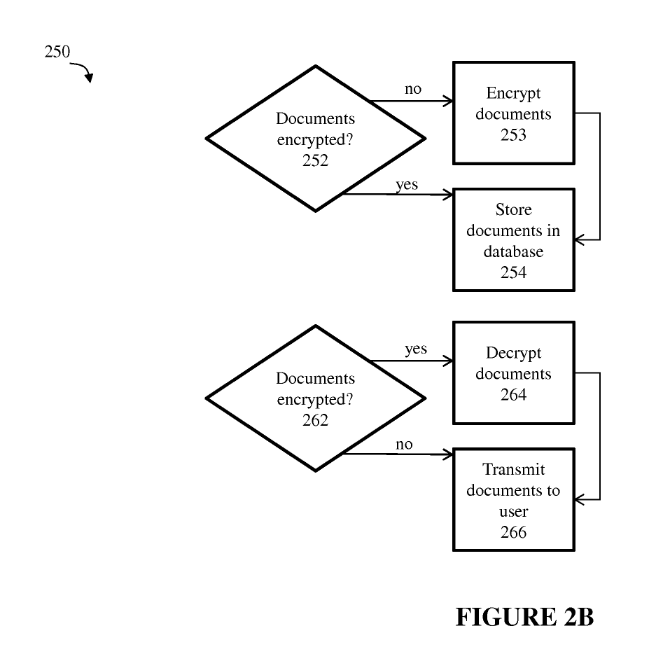

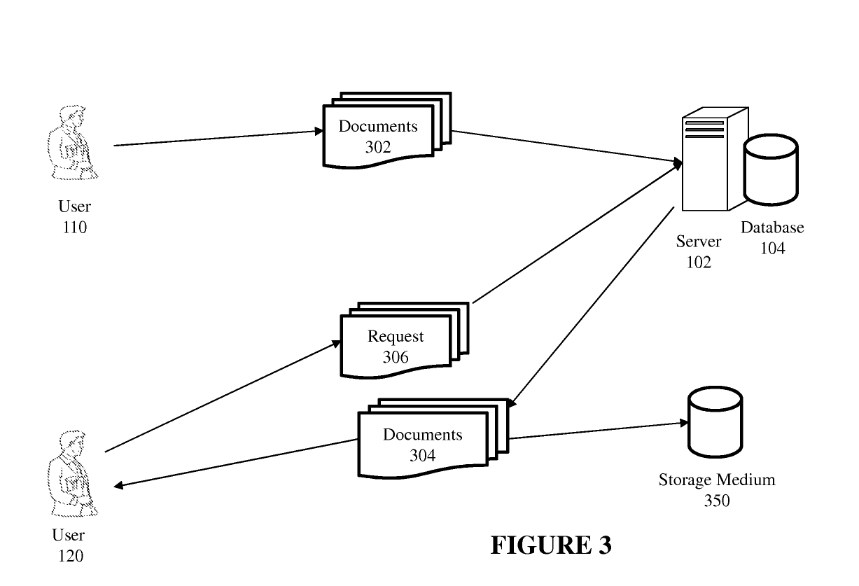

The process of the disclosed embodiments will now be described with reference to FIGS. 2A, 2B and 3, which illustrate the data flow and control flow for an electronic discovery management system over a communications network, in accordance with one embodiment. The system can be used by plaintiffs and defendants during the discovery process of a court case, as well as their agents and vendors, such as investigators, copy centers, document processors, claims administrators, insurance adjusters, mediators, etc. For the purposes of describing FIGS. 2A, 2B and 3, the following scenario is assumed: a lawsuit requiring electronic discovery has commenced between users 110 and 120 and user 110 must produce electronic documents to user 120. A client can be any user's computing device (112, 122) executing an application, such as a mobile application.

In first step 202, a user 110 would transmit a plurality of electronic documents 302 via the communications network 106 (using a standard communications protocol such as HTTP or HTTPS) to the server 102 of the electronic discovery management system. In step 204, the electronic documents 302 are stored in the attached database 104. In this step, the server 102 generates a fingerprint of each of the electronic documents 302, by executing a fingerprinting algorithm on each electronic document, and associating each fingerprint with a corresponding electronic document in the database.

In one alternative to step 204, steps 252 through 254 are executed. In this alternative, the server 102 determines, in step 252 whether the documents 302 are encrypted. If the document is encrypted (wherein the device 112 of user 110 encrypted the documents, for example), then control flows to step 254. If the documents are not encrypted, then control flows to step 253, wherein the documents are encrypted by server 102. Encryption is the process of encoding data in such a way that only authorized parties can read it. Various forms of encryption well known in the art may be used, including symmetric encryption and public key encryption. Subsequently, the server 102 generates a fingerprint of each of the encrypted documents 302, and associates each fingerprint with a corresponding encrypted document in the database.

In another embodiment, at least 1 million documents are stored in step 204 or in multiple executions of step 204. Recall that this number of records is significant in the industry because it represents a minimum number of records that are present in a typical medium to large sized litigation, and it represents a minimum number of documents required in order to make the costs of said litigation cost feasible. Thus, in this embodiment, in step 204, the server 102 stores at least 1 million documents (at once or in a batch).

In step 206, a request 306 by a user, such as user 120, for a first set of electronic documents of the plurality of electronic documents 302 is received via network 106. In step 208, the server 102 accesses the first set of electronic documents 304 in the database 104, and in step 210 the server 102 generates a subsequent fingerprint for each document of the first set of electronic documents 304. In step 212, for each document of the first set of electronic documents 304 the server 102 compares the subsequent fingerprint with the corresponding fingerprint stored in association with said document in the database 104. In step 214 thee server 102 determines whether, for each document of the first set of electronic documents 304, the subsequent fingerprint is identical to the fingerprint stored in the database. If, for each document of the first set of electronic documents 304, the subsequent fingerprint is identical to the fingerprint stored in the database, then the first set of electronic documents 304 are authentic with all integrity maintained, and control flows to step 216. If, for any document of the first set of electronic documents 304, the subsequent fingerprint is different from (or not identical to) the corresponding fingerprint stored in the database, then said documents are not authentic and have lost integrity, and control flows to step 217.

Thus, if the result of the inquiry of step 214 is positive, then in step 216, the server 102 generates a confirmation report stating that the subsequent fingerprint is identical to the fingerprint and, in step 218, the server transmits, over the communications network 106, such confirmation report along with the first set of documents 304 to the user 120 or other requesting party. When the subsequent fingerprint and stored fingerprint of a document (or group of documents) are compared and determined to be identical, then such document (or group of documents) has been authenticated and it is suitable for admitting into evidence in a court of law. In one embodiment, a confirmation report is a text based document that confirms in writing that the subsequent fingerprint and stored fingerprint of a document (or group of documents) have been compared and are determined to be identical.

If the result of the inquiry of step 212 is negative, then in step 217, the server generates a modification report stating that the subsequent fingerprint is different from the stored fingerprint (and optionally stating that such corresponding document has been modified) and, in step 218, server 102 transmits, over the communications network 106, such modification report (and optionally the first set of documents 304) to the user 120 or other requesting party. When the subsequent fingerprint and stored fingerprint of a document (or group of documents) are compared and determined to be different, then such document (or group of documents) has been altered and is not suitable for admitting into evidence in a court of law. In one embodiment, a modification report is a text based document that indicates in writing that the subsequent fingerprint and stored fingerprint of a document (or group of documents) have been compared and are determined to be different or not identical. A modification report may also indicate how the fingerprints are different or how the document has been modified.

In one alternative to step 218, steps 262 through 266 are executed. In this alternative, the server 102 determines, in step 262 whether the documents 304 are encrypted. If the document is encrypted, then control flows to step 264, wherein the documents are encrypted by server 102. If the documents are not encrypted, then control flows to step 266. Subsequently, the server 102 transmits each of the decrypted documents 304 to the user.

In one alternative to step 218, the requested documents are transmitted for storage in a storage medium instead of transmitted to a user. In this alternative, server 102 may be configured for receiving a request 306, over the communications network 106, to store a second set of documents of the plurality of documents on a remote storage medium 350. Similar to the process flow above, after receiving the request 306 to store a second set of documents, the server 102 then accesses the second set of documents in the database 104. Next, similar to the process flow above, the server 102 generates a subsequent fingerprint for each document of the second set of documents, and compares said subsequent fingerprints with a corresponding fingerprint stored in association with said document in the database 104.

After comparing the subsequent fingerprints with the stored fingerprints, if for each document of the second set of documents, the server 102 determines that said subsequent fingerprint is identical to the fingerprint stored in association with said document in the database 104, the server 102 then generates a confirmation report stating that the fingerprints are identical and the documents have not been altered. Then, the server 102 can transmit, over the communications network 106, the second set of documents and confirmation report to the remote storage medium 350 for storage. In one alternative, server 102 may also execute steps 262 through 266 above before the transmission step. It is worth noting that the confirmation report may also include other pertinent information that may be necessary or useful to the users 110, 120 or other third parties, such as time stamps, or other document data (as described above).

On the other hand, after comparing the subsequent fingerprints with the stored fingerprints, if for each document of the second set of documents the server 102 determines that said subsequent fingerprint is not identical to the fingerprints stored in association with said document in the database 104, then the server 102 can generate a modification report stating that the subsequent fingerprint is not identical to the stored fingerprint. As a result, the server 102 would transmit, via the communications network 106, the modification report with the second set of documents to the remote storage medium 350 for storage. In one alternative, server 102 may also execute steps 262 through 266 above before the transmission step.

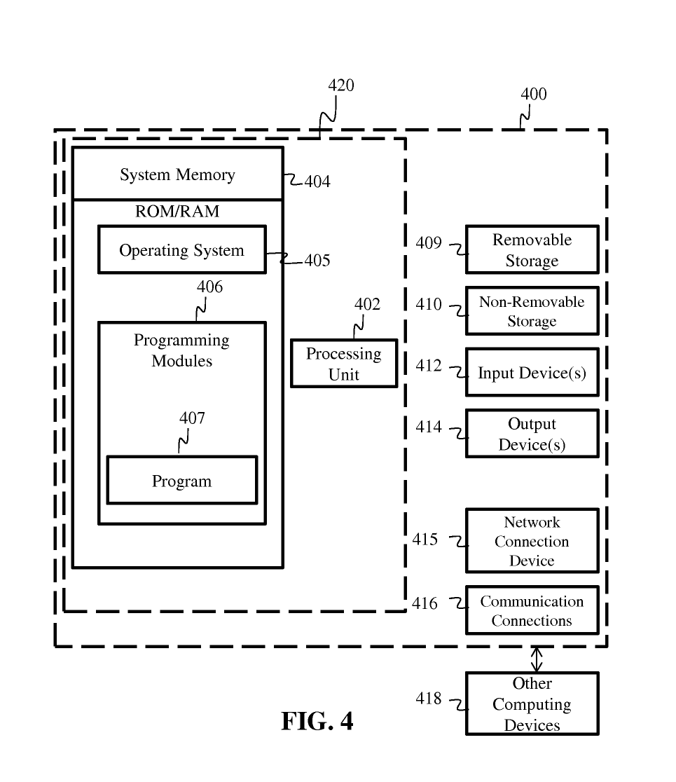

FIG. 4 is a block diagram of a system including an example computing device 400 and other computing devices. Consistent with the embodiments described herein, the aforementioned actions performed by 102, 112, 122 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2A-3 above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods shown in FIGS. 2A-3 above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. An electronic discovery management system communicatively coupled with a communications network, comprising:
a) a database for storing a plurality of electronic documents, wherein each electronic document is associated with a fingerprint of said document, the database coupled to the communications network; and
b) a server communicatively coupled with the communications network and with the database, the server configured for:
1) receiving a plurality of documents via the communications network, and storing the plurality of documents in the attached database;
2) generating a fingerprint of each document, by executing a mapping algorithm on each document that maps document data to a shorter bit string, wherein each fingerprint is associated with a corresponding document in the database;
3) receiving a request from a user, over the communications network, for a first set of documents of the plurality of documents;
4) accessing the first set of documents in the database;
5) generating, for each document of the first set, a subsequent fingerprint and comparing said subsequent fingerprint with a corresponding fingerprint stored in association with said document in the database;
6) if, for each document of the first set, said subsequent fingerprint is identical to the fingerprint stored in association with said document in the database, then transmitting, over the communications network, the first set of documents to said user;
7) receiving a request, over the communications network, to store a second set of documents of the plurality of documents on a remote storage medium;
8) accessing the second set of documents in the database;
9) generating, for each document of the second set, a subsequent fingerprint for and comparing said subsequent fingerprint with a corresponding fingerprint stored in association with said document in the database; and
10) if, for each document of the second set, said subsequent fingerprint is identical to the fingerprint stored in association with said document in the database, then transmitting, over the communications network, the second set of documents to the remote storage medium for storage.

2. The electronic discovery management system of claim 1, wherein the electronic discovery management system receives and transmits documents via the communications network using HTTP or HTTPS.

3. The electronic discovery management system of claim 2, wherein the server is further configured for:
generating, for each document of the first set, a confirmation report stating that the subsequent fingerprint is identical to the fingerprint stored in association with said document in the database; and
transmitting to the user, over the communications network, said confirmation reports with the first set of documents.

4. The electronic discovery management system of claim 3, wherein the server is further configured for:
generating, for each document of the first set, a modification report stating that the subsequent fingerprint is not identical to the fingerprint stored in association with said document in the database; and
transmitting to the user, over the communications network, said modification reports with the first set of documents.

5. The electronic discovery management system of claim 4, wherein the server is further configured for:
generating, for each document of the second set, a confirmation report stating that the subsequent fingerprint is identical to the fingerprint stored in association with said document in the database; and
transmitting to the remote storage medium, over the communications network, said confirmation reports with the second set of documents.

6. The electronic discovery management system of claim 5, wherein the server is further configured for:
generating, for each document of the second set, a modification report stating that the subsequent fingerprint is not identical to the fingerprint stored in association with said document in the database; and
transmitting to the remote storage medium, over the communications network, said modification reports with the second set of documents.

7. An electronic discovery management system communicatively coupled with a communications network, comprising:
a) a database for storing a plurality of electronic documents, wherein each electronic document is associated with a fingerprint of said document, the database coupled to the communications network; and
b) a server communicatively coupled with the communications network and with the database, the server configured for:
1) receiving a plurality of documents via the communications network, and storing the plurality of documents in the attached database;
2) encrypting each of the plurality of documents, so as to produce a plurality of encrypted documents;
3) generating a fingerprint of each encrypted document, by executing a mapping algorithm on each encrypted document that maps document data to a shorter bit string, wherein each fingerprint is associated with a corresponding encrypted document in the database;
4) receiving a request from a user, over the communications network, for a first set of documents of the plurality of documents;
5) accessing, in the database, a first set of encrypted documents corresponding to the first set of documents that were requested;
6) generating, for each encrypted document of the first set, a subsequent fingerprint and comparing said subsequent fingerprint with a corresponding fingerprint stored in association with said encrypted document in the database;
6) if, for each encrypted document of the first set, said subsequent fingerprint is identical to the fingerprint stored in association with said encrypted document in the database, then decrypting the first set of encrypted documents, so as to produce a first set of decrypted documents, and transmitting, over the communications network, the first set of decrypted documents to said user;
7) receiving a request, over the communications network, to store a second set of documents of the plurality of documents on a remote storage medium;
8) accessing, in the database, a second set of encrypted documents corresponding to the second set of documents;
9) generating, for each encrypted document of the second set, a subsequent fingerprint for and comparing said subsequent fingerprint with a corresponding fingerprint stored in association with said encrypted document in the database; and
10) if, for each document of the second set, said subsequent fingerprint is identical to the fingerprint stored in association with said encrypted document in the database, then decrypting the second set of encrypted documents, so as to produce a second set of decrypted documents and transmitting, over the communications network, the second set of decrypted documents to the remote storage medium for storage.

8. The electronic discovery management system of claim 7, wherein the electronic discovery management system receives and transmits documents via the communications network using HTTP or HTTPS.

9. The electronic discovery management system of claim 8, wherein the server is further configured for:
generating, for each encrypted document of the first set, a confirmation report stating that the subsequent fingerprint is identical to the fingerprint stored in association with said encrypted document in the database; and
transmitting to the user, over the communications network, said confirmation reports with the first set of decrypted documents.

10. The electronic discovery management system of claim 9, wherein the server is further configured for:
generating, for each encrypted document of the first set, a modification report stating that the subsequent fingerprint is not identical to the fingerprint stored in association with said encrypted document in the database; and
transmitting to the user, over the communications network, said modification reports with the first set of decrypted documents.

11. The electronic discovery management system of claim 10, wherein the server is further configured for:
generating, for each encrypted document of the second set, a confirmation report stating that the subsequent fingerprint is identical to the fingerprint stored in association with said encrypted document in the database; and
transmitting to the remote storage medium, over the communications network, said confirmation reports with the second set of decrypted documents.

12. The electronic discovery management system of claim 11, wherein the server is further configured for:
generating, for each encrypted document of the second set, a modification report stating that the subsequent fingerprint is not identical to the fingerprint stored in association with said encrypted document in the database; and
transmitting to the remote storage medium, over the communications network, said modification reports with the second set of decrypted documents.

13. An electronic discovery management system communicatively coupled with a communications network, comprising:
a) a plurality of users having computing devices communicably connected to the communications network, wherein each computing device is configured for transmitting and receiving requests and documents via the communications network;
b) a database for storing a plurality of electronic documents including at least 1 million documents, wherein each electronic document is associated with a fingerprint of said document, the database coupled to the communications network; and
c) a server communicatively coupled with the communications network and with the database, the server configured for:
1) receiving a plurality of documents including at least 1 million documents via the communications network, and storing the plurality of documents in the attached database;
2) generating a fingerprint of each document, by executing a mapping algorithm on each document that maps document data to a shorter bit string, wherein each fingerprint is associated with a corresponding document in the database;
3) receiving a request from a user, over the communications network, for a first set of documents of the plurality of documents;
4) accessing the first set of documents in the database;
5) generating, for each document of the first set, a subsequent fingerprint and comparing said subsequent fingerprint with a corresponding fingerprint stored in association with said document in the database;
6) if, for each document of the first set, said subsequent fingerprint is identical to the fingerprint stored in association with said document in the database, then transmitting, over the communications network, the first set of documents to said user;
7) receiving a request, over the communications network, to store a second set of documents of the plurality of documents on a remote storage medium;
8) accessing the second set of documents in the database;
9) generating, for each document of the second set, a subsequent fingerprint for and comparing said subsequent fingerprint with a corresponding fingerprint stored in association with said document in the database; and
10) if, for each document of the second set, said subsequent fingerprint is identical to the fingerprint stored in association with said document in the database, then transmitting, over the communications network, the second set of documents to the remote storage medium for storage.

14. The electronic discovery management system of claim 13, wherein the electronic discovery management system receives and transmits documents via the communications network using HTTP or HTTPS.

15. The electronic discovery management system of claim 14, wherein the server is further configured for:
generating, for each document of the first set, a confirmation report stating that the subsequent fingerprint is identical to the fingerprint stored in association with said document in the database; and
transmitting to the user, over the communications network, said confirmation reports with the first set of documents.

16. The electronic discovery management system of claim 15, wherein the server is further configured for:
generating, for each document of the first set, a modification report stating that the subsequent fingerprint is not identical to the fingerprint stored in association with said document in the database; and
transmitting to the user, over the communications network, said modification reports with the first set of documents.

17. The electronic discovery management system of claim 16, wherein the server is further configured for:
generating, for each document of the second set, a confirmation report stating that the subsequent fingerprint is identical to the fingerprint stored in association with said document in the database; and
transmitting to the remote storage medium, over the communications network, said confirmation reports with the second set of documents.

18. The electronic discovery management system of claim 17, wherein the server is further configured for:
generating, for each document of the second set, a modification report stating that the subsequent fingerprint is not identical to the fingerprint stored in association with said document in the database; and
transmitting to the remote storage medium, over the communications network, said modification reports with the second set of documents.
